(19) United States
(12) Patent Application Publication
(10) Pub. No.: US 2010/0074497 A1
(43) Pub. Date: Mar. 25, 2010

(54) STABILIZATION OF IMAGING METHODS IN MEDICAL DIAGNOSTICS

(76) Inventor: HOLGER MIELENZ, Ostfildern (DE)

Correspondence Address: KENYON & KENYON LLP, ONE BROADWAY, NEW YORK, NY, 10004, US

(21) Appl. No.: 12/557,500

(22) Filed: Sep. 10, 2009

(30) Foreign Application Priority Data
Sep. 10, 2008 (DE) 102008041941.9

(51) Int. Cl. G06K 9/00

(52) U.S. Cl. 382/131; 382/128

(57) ABSTRACT

A method is provided for stabilizing imaging methods in medical diagnostics, in which a three-dimensional surface contour of a patient is acquired and is correlated with at least one imaging method. In addition, the present invention provides a corresponding medical diagnostic device.

### CROSS-REFERENCE TO RELATED APPLICATIONS

The present application claims priority to German Application No. 102008041941.9, filed in the Federal Republic of Germany on Sep. 10, 2008, which is expressly incorporated herein in its entirety by reference thereto.

### FIELD OF INVENTION

The present invention relates to a method for stabilizing imaging methods in medical diagnostics, as well as to corresponding diagnostic devices.

### BACKGROUND INFORMATION

Various imaging methods are used for medical diagnostics. In conventional x-ray methods, the object to be imaged is transilluminated by an x-ray source and is imaged on an x-ray film. The projection of the volume onto a surface has various disadvantages, so that in recent decades computer tomography (CT) was developed, with significant improvements in the representation of images. Here, many x-ray images are made of the object, e.g., of the patient, from various directions. From these images, a three-dimensional reconstruction is subsequently produced. As a rule, this is represented as a series of individual sections. These image sequences are stored as image data sets and can be used for diagnostic purposes. In addition to a two-dimensional view of the sections, a three-dimensional representation can also be achieved by data processing of the tomograms. In this way, anatomical details of the patient can be illustrated, making possible an improved diagnosis of anatomical anomalies. However, computer tomography requires significant exposure of the patient to radiation.

Another imaging method used in medical technology is magnetic resonance tomography (MRT). Magnetic resonance tomography is based on the production of very strong magnetic fields that excite certain atomic nuclei in the body. The excited atomic nuclei produce weak electromagnetic fields that can be acquired and correspondingly evaluated. Magnetic resonance tomography also makes it possible to produce tomograms of an organism, e.g., of a patient, permitting a diagnosis.

However, there are various illnesses that cannot be represented, or can be represented only with great difficulty, using these methods, insofar as the anomalies do not have a clear effect on the anatomical structures that can be represented using computer tomography and magnetic resonance tomography. For example, cancer cells cannot be recognized in a computer tomography image until a relatively late point in time, by which time they may have formed non-physiological structures such that a therapy having likelihood of success can no longer be carried out. In the area of cancer diagnosis and cancer therapy, early localization is needed so that targeted therapeutic measures can be introduced, or so that, e.g., the success of a section, or of some other treatment, can be confirmed.

Thus, the imaging methods of computer tomography or of magnetic resonance tomography are supplemented by further methods of molecular imaging that enable recognition of anomalies that would not be visible given purely anatomical representation of the structures.

One possibility for molecular imaging is positron emission tomography (PET). This is an imaging method used in nuclear medicine that is capable of producing tomograms of living organisms by making visible the distribution of a radioactively marked substance in the organism. Here, the patient can, e.g., be administered markers that are metabolism-specific, marked with a short-lived positron radiator. Through suitable selection of the marker, biochemical or physiological functions in the body can be imaged. For example, because cancer cells have increased metabolic activity with a higher rate of absorption of glucose, the administration of marked glucose molecules can bring about a concentration of the marker in cancer cells. This distribution of the marker, and thus, the position or localization of the cancer cells, can be imaged as locus-resolved detection of the positron decay events during the course of the positron emission tomography. Other suitable areas of application of positron emission tomography include, e.g., problems in neurology or cardiology.

Tomograms created by positron emission tomography do allow diagnosis of a tumor, or a recognition of cancer cells, but the anatomical features can be recognized only very imprecisely. A clear localization of cancer cells or of a tumor is possible only with great difficulty. For these reasons, various imaging methods are used in combination with PET. For example, computer tomography pictures have been fused with tomograms from position emission tomography, enabling a more detailed local resolution of diseased tissue. For this purpose, the signals produced during a computer tomography session, as well as the signals from a positron emission tomography session, are each prepared in a corresponding manner. During a sectional plane correlation, the results are fused. The result of this can then be visually displayed using an arbitrary imaging method. A corresponding combination and correlation of various image data sets is possible in a comparable manner using a combination of magnetic resonance tomography and positron emission tomography.

The quality of the localization sharpness of the various imaging methods in medical diagnostics, e.g., given a combination of different methods, e.g., CT/PET or MRT/PET, depends crucially on the precision with which the local correlation of the sensor systems used can be resolved.

The fusion of the various image data sets results in occurrences of unsharpness that make the diagnosis more difficult. Therefore, various methods have already been proposed that facilitate working with the correlated image data sets. For example, German patent reference DE 10 2006 025 761 A1 proposes a method for image-supported analysis of image data sets, correlated with one another, of a computer tomograph and of a positron emission tomograph, in which the computer tomography image data sets are continuously displayed in an image sequence, and the corresponding PET image data sets are simultaneously examined for an anomaly. When an anomaly is recognized, the continuous display of the image data sets is halted, so that the correlated CT image data set having the anomaly is displayed on a display device and can be examined in detail. German patent reference DE 10 2006 027 670 A1 proposes a method for reducing image-based artifacts in a combined CT/PET. Here, particular image values are identified and modified using corresponding filters in order to improve the precision of the image representation.

A significant problem with the combination of the different imaging methods, and with the different imaging methods each considered in themselves, is caused by the time duration required by the various methods for acquiring the corresponding signals during the tomography. While a computer tomography according to the current state of the art requires less than one minute for a complete screening, positron emission tomography signals must be integrated over a longer period of time at a location, i.e. in a sectional plane, so that a reliable signal can be derived. Thus, a PET screening currently takes about 15 to 30 minutes. Even slight changes in the position of the patient during the exposure time can cause significant unsharpness and imprecision in the PET image. This problem becomes worse when the image data are combined with data from other imaging methods, e.g., when combined with CT image data. These noise influences arise predominantly due to the changes in position of the patient, or, e.g., even due to the patient's breathing movements. The noise effects are thus based on the relatively long time constants of the systems, and, e.g., on the different time constants of the individual systems in the case of a combination of different imaging methods. Immobilization of the patient, and even with use of anesthesia, can limit the changes in position of the thorax and of the movement apparatus, but cannot completely eliminate these. In the case of positron emission tomography, with its relatively long required signal exposure, the patient's breathing has a significant influence on the tomographic representation. Due to the movement of the abdominal wall during breathing, the organs also undergo a change of localization, resulting in significant localization unsharpness during the temporal integration of the PET signals. For example, a risk is found in the case of a positron emission tomography session carried out in the early stages of cancer or after incomplete selection of cancer cells, because here the PET signals can often sink below the noise limit, so that even faulty localization is no longer possible.

In order to solve this problem, German patent reference DE 10 2006 025 761 A1 proposes a method according to which, after an initial CT screening, anomalies are analyzed using positron emission tomography. If an anomaly is detected to any extent, the CT sections in the area of the detected focus are carried out again, thus improving the local resolution. However, in this case the examination will last significantly longer, exposing the patient to a much greater amount of radiation, and causing significantly higher costs.

In order to overcome the described problems, embodiments of the present invention provide a method and a device that reduces the localization unsharpness of conventional imaging methods in medical diagnostics, in order to improve a diagnosis of anomalies, or in some cases to make such a diagnosis possible. Immobilization, which is unpleasant for the patient, and even anesthesia of the patient, are to be avoided. In addition, in an embodiment, the screening method is to be carried out as quickly and efficiently as possible, saving costs on the one hand and reducing the patient's radiation dosage on the other hand.

### SUMMARY OF INVENTION

Example embodiments of the present invention provide a method for stabilizing imaging methods in medical diagnostics, and a medical diagnostics device to effect same.

Example embodiments of the present invention provide a method for stabilizing imaging methods in medical diagnostics in which a three-dimensional surface contour of the object is examined, e.g., of a patient, is acquired, and is correlated with at least one imaging method, e.g., with data sets from this method. In this way, using imaging methods that require longer exposure times, a change in position of the object, or of the patient, can be acquired and followed, and can be taken into account in the evaluation of the imaging methods through suitable correlation of the various items of information. This permits significant improvement of the local resolution or localization sharpness of the imaging methods, and thus of the sensitivity.

In example embodiments of the present invention, the three-dimensional surface contour is acquired multiple times during the execution of the imaging method, in particular during the exposure times, and is correlated, simultaneously or subsequently to the exposure time, with the data of the imaging method. Changes in the position of the patient are acquired during the exposure times of the imaging methods and are correlated with the data of the imaging methods, so that noise influences caused by movement can be avoided. During the execution of the imaging method, a separate reference model of the patient can be produced that is used for the transformation of possible movement profiles, excluding the influence of the movement on the imaging method through corresponding taking into account of the reference model. Preferably, at each acquisition time or for each scanning cycle during the exposure times in the execution of the imaging method, a reference model of the patient can be produced by acquiring the three-dimensional surface contour. In other specific embodiments, fewer acquisition times can be provided during the execution of the imaging method, and additional data may be interpolated as needed for the reference model or for the surface contour of the patient.

In example embodiments of the present invention, laser beams are used to produce the three-dimensional surface contour. Here, use is made in particular of the so-called LIDAR method. LIDAR stands for “Light Detection and Ranging.” This method has been used to measure the distance and speed of various parameters, the delay time between the transmission of a laser pulse and the detection of the reflected signal being acquired and placed into relation with a distance. According to embodiments of the present invention, with this use of laser beams, or laser pulses, it is possible to acquire the three-dimensional surface contour of the object, i.e., of the patient, and thus to produce a reference model of the patient that can be correlated with the data of a medical diagnostics imaging method. Here, e.g., using laser pulses of laser class 1, which are essentially physiologically harmless to the patient, the surface contours can be acquired with specifiable scanning rates. These contours are used for the norming of the measurement signals of the sensor systems, e.g., CT and PET, used in the course of the diagnostic imaging methods. In an example embodiment of the present invention, the corresponding laser beams or laser pulses are sent out by one, e.g., by a plurality, of LIDAR laser scanners, and the reflected signals are detected. In an embodiment, with the aid of the surface contour acquired in this way, the movement patterns of the patient can be back-calculated. This achieves an essentially higher resolution of the imaging methods. In embodiments of the present invention, even for imaging methods having relatively short exposure time, this method results in a reduction of the noise influences and improvement of the resolution, e.g., in computer tomography. In embodiments of the present invention, the advantages are brought to bear in a quite particular manner in imaging methods that require longer exposure time. Example embodiments of the method and system according to the present invention can be used to great advantage in connection with positron emission tomography, which is found to require relatively low sensitivity and long integration times.

In example embodiments of the present invention, two or more LIDAR laser scanners are used. The use of a plurality of laser scanners, or corresponding sensors, permits scanning of the surface contours with a higher resolution and with shorter cycle times, improving the acquisition of the three-dimensional surface contour.

In example embodiments, the imaging method is a computer tomography (CT) method, a magnetic resonance tomography (MRT) method, and/or a positron emission tomography (PET) method. In example embodiments, the method is used with imaging methods that require a longer integration time, such as PET and MRT. In example embodiments, by correlating the data from the imaging method with data for the three-dimensional surface contour of the patient during the exposure duration of the imaging method, significantly better resolutions and localizations can be achieved. Example embodiments can be used in connection with combined imaging methods, e.g., with a CT/PET method or an MRT/PET method. In these combined imaging methods, the noise effects of the individual methods reinforce one another significantly. Due to the circumstance that the individual noise effects can be reduced through the acquisition of the three-dimensional surface contour according to a method embodiment of the present invention, the resolution and, thus, the sensitivity of these combined methods is increased during the acquisition of the three-dimensional surface contour of the patient according to the present invention.

In addition to the named imaging methods from diagnostic medical technology, example embodiments of the present invention may also be applied with other imaging methods whose sensitivity is a function of a movement behavior of the object, e.g., a patient. An example of an imaging method that can be used in the context of the present invention is thermography. For example, thermal cameras can be used to diagnose illnesses that are close to the surface via temperature gradients, in comparison with physiologically normal tissue. For example, in comparison with non-diseased tissue, mamma carcinomas, malignant melanomas, inflammations, and blood vessel diseases show a temperature difference of between 0.5 K and 4 K. The sharpness of thermographic data can be improved by the correlation with the three-dimensional surface contour of a patient in an embodiment of the present invention.

In an example embodiment of the present invention, the three-dimensional surface contour is used as a reference coordinate system for the imaging method. For this purpose, e.g., the three-dimensional surface contour is acquired in each scanning cycle of the imaging method, simultaneously or in temporal connection therewith. In an embodiment, in a subsequent processing of the data, the reference coordinate system is placed into correlation with the data or signals of the imaging method, so that movements or changes in position of the patient can be back-calculated. In the case of combined imaging methods, the reference coordinate system is preferably used during a sectional plane correlation of the imaging methods, for example CT and PET and/or MRT and PET. The correspondingly prepared signals can be visually presented via an imaging interface, for example a personal computer, and can form an improved basis for diagnostic examination.

In the embodiments of the present invention having combined imaging methods CT/PET, the embodiment permits a reduction of noise influences caused, e.g., by movements or changes in the position, of the patient during the PET signal integration. A reduction of the noise influences, e.g., in positron emission tomography but also in computer tomography, makes possible a reliable diagnosis even of smaller cancer cell clusters, by increasing the sensitivity and precision. As a further advantage, the patient no longer has to undergo immobilization, which in some circumstances can be painful, during the exposure of the imaging method, in particular during PET.

Compared to computer tomography, magnetic resonance tomography requires a significantly longer exposure duration. Thus, for example, during a magnetic resonance tomography session an acquisition of the three-dimensional surface contour and a correlation of these data with the data of the imaging method can achieve a significant improvement in resolution and thus in precision and sensitivity. This advantage is brought to bear in particular given a combination of MRT with PET in the manner described above. In the case of an MRT as well, immobilization or even anesthesia of the patient is often required in conventional methods in order to avoid changes in the position of the patient to the greatest possible extent. Immobilization, which is very unpleasant for the patient during an MRT, can be avoided in the execution of the method according to the present invention.

In comparison with computer tomography, magnetic resonance tomography has the advantage that the patient does not have to be exposed to a dose of radiation. The unsharpness that occurs in conventional magnetic resonance tomography images, resulting from movements of the patient, is avoided in the method of the present invention, so that the disadvantage of longer exposure durations during an MRT in comparison with a CT, with increased exposure to radiation, is removed by the method according to the present invention.

An example embodiment of the present invention includes, at least one device being provided for the production of a three-dimensional surface contour of a patient, in order, e.g., to stabilize the imaging. In an embodiment, the device for producing the three-dimensional surface contour is at least one laser scanner or at least one LIDAR scanner. For example, two or more laser scanners are provided in order to enable shorter cycle times and to improve the scanning of the surface contours.

In an embodiment of the present invention, the diagnostic device additionally has means for correlating the three-dimensional surface contour with the imaging. For this purpose, e.g., a standard computing unit, e.g., a computer, can be provided that can be equipped with corresponding programs for carrying out the correlation, and if warranted for a visualization of the results.

In example embodiments of the present invention, the imaging device is at least one computer tomograph (CT), at least one magnetic resonance tomograph (MRT), and/or at least one positron emission tomograph (PET). Particularly advantageously, the imaging device is combined imaging devices or a combination of corresponding imaging devices, e.g., a CT/PET combination and/or an MRT/PET combination.

With regard to additional features of the medical diagnostic device according to the present invention, reference is made to the description herein.

In example embodiments of the present invention, the present invention includes the use of a three-dimensional surface contour of a patient for the stabilization of imaging methods in medical diagnostics. For example, laser beams, e.g., laser beams of a scanning LIDAR method, are used to acquire the three-dimensional surface contour. Reference is made to the above description with regard to further features of the use according to the present invention.

Example embodiments of the present invention include a computer program for executing the method for stabilizing imaging methods in medical diagnostics as described above, as well as a computer program product having program code that is stored on a machine-readable carrier for the execution of the method according to the present invention.

Further features and advantages of the present invention result from the following description of the Figures in combination with the exemplary embodiments and the subclaims. The various features may be realized individually or in combination with one another.

### BRIEF DESCRIPTION OF THE DRAWINGS

FIG. 1 shows a schematic representation of a system for executing an embodiment according to the present invention.

FIG. 2 shows a schematic representation of the execution and the effect of an embodiment according to the present invention.

FIG. 3 shows a schematic representation of a system for executing an embodiment method according to the present invention.

### DETAILED DESCRIPTION

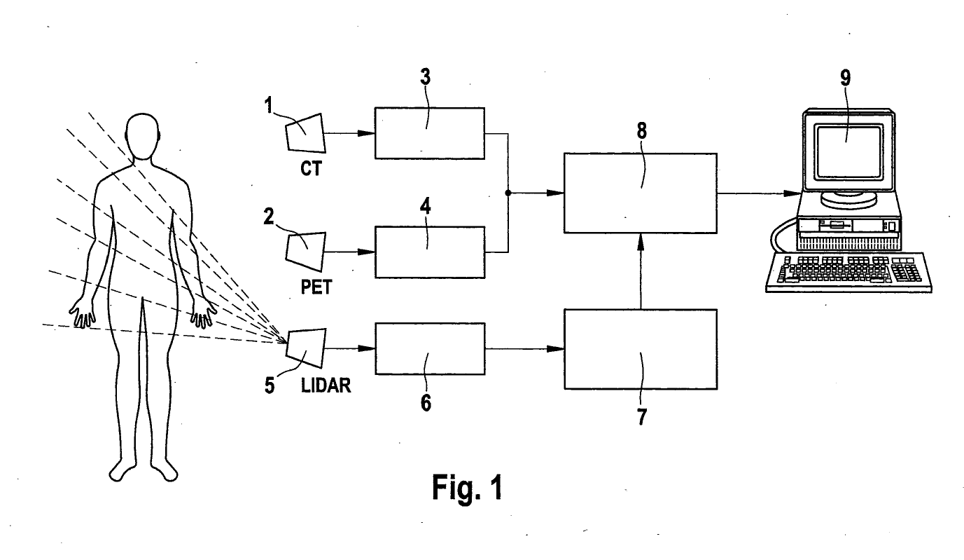

FIG. 1 illustrates a system that is suitable for executing the method according to the present invention. Components 1 and 2, designated CT and PET, of a diagnostic device here stand for measurement devices or sensor systems that are suitable for imaging for diagnostic purposes. Instead of CT and PET, for example MRT and PET may be provided in a corresponding manner. In addition, instead of a combination of different imaging methods, individual imaging methods, for example CT, MRT, or PET, may be used without being combined with another imaging method. For example, after corresponding signal preparation 3, 4, sensor systems CT and PET, or corresponding scanners, supply image data sets of a computer tomography and of a positron emission tomography of the patient. In a further embodiment, this system includes a LIDAR scanner or LIDAR sensor 5 that scans the three-dimensional surface contour of the patient by sending out laser pulses and receiving the reflected signals. A signal preparation 6 is carried out for these signals. From the prepared signals, a reference model 7 is produced of the surface contour of the patient.

The scanning of the surface contour of the patient takes place over time, so that a profile of the change in position or movement of the patient is followed using LIDAR sensor 5, and can be reproduced as data. The laser pulses sent out by LIDAR sensor 5 are physiologically compatible with the patient (laser class 1). For example, with high scanning rates, the surface contours of the patient can be acquired over time and the data can be correspondingly prepared.

The data from LIDAR scanner 5 is taken into account, in the form of produced reference model 7, during a sectional plane correlation 8 of the prepared signals from sensor systems 1 and 2, in that the movements or positional changes of the patient acquired in patient reference model 7 are used for the norming of the measurement signals of CT and PET sensor systems 1 and 2.

Because positron emission tomography requires a relatively long exposure time, the changes in the patient's position that unavoidably occur during this time result in unsharpness of the localization of the signals. In computer tomography as well, despite the relatively short exposure times the smallest movements have an effect on the sharpness of the images. This unsharpness is reinforced in the case of a combination of the two imaging methods. Through matching with the movement profile of the patient (or other object), acquired using LIDAR sensor 5, the movement-dependent localization changes are removed, which can significantly increase the localization sharpness and thus also the sensitivity of the method.

In an embodiment, the fused CT and PET data, correlated with patient reference model 7, are visualized via an imaging interface 9, for example, on a standard monitor of a personal computer.

In example embodiments of the present invention, the scanning of the surface contour of the patient using LIDAR sensor 5 takes place during each scan cycle of the CT and PET imaging methods, so that the data of the surface contour can easily be used as a reference coordinate system in a subsequent sectional plane correlation of PET and CT. In embodiments, the scan rate of the LIDAR sensor can be reduced, and if warranted corresponding data for the movement profile can be interpolated.

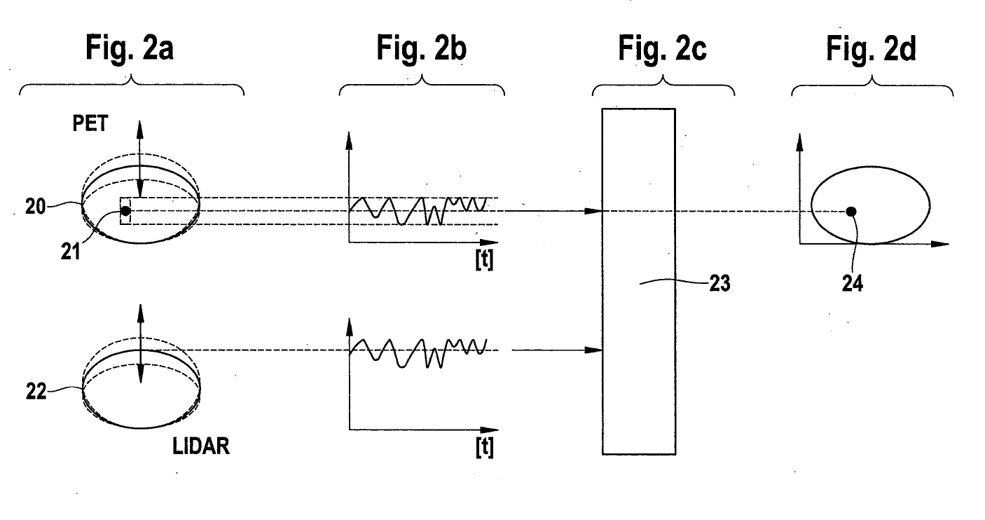

FIG. 2 illustrates the execution and the result of the method according to the present invention on the basis of a lateral cross-section 20 through the abdominal cavity of a patient having a colon carcinoma 21. In the upper part of FIG. 2a), there is a schematic representation of a positron emission tomography image, with the signals of colon carcinoma 21. The broken lines and the arrow illustrate the patient's breathing movements. This causes a localization unsharpness of carcinoma 21, as illustrated in the representation of the signal plotted against recording time (t) in FIG. 2b). Given an integration of the PET signal and correlation with an initially produced CT section, this would result in a faulty localization, or a very unsharp localization, of the carcinoma. In order to solve this problem, an example embodiment according to the present invention provides that, parallel with or temporally close to each PET scan cycle, laser beams are used, in the LIDAR method, to acquire the three-dimensional surface contour of the patient. After corresponding signal processing, a three-dimensional surface reference model 22 of the patient can be produced therefrom, as is shown schematically in the lower part of FIG. 2a). This reference model 22 reproduces the breathing movements indicated in broken lines and by the arrow, and thus, reproduces associated changes in position of the organs. The signals of the LIDAR sensor, plotted over the recording time of the PET parallel to the PET scan, are shown in the lower representation of FIG. 2b). In embodiments, these signals are used as a coordinate reference system for the detected PET signals and CT signals, so that a scaling 23 of the signals of an initially performed CT and of the PET can be carried out. This can bring about a significant reduction of the noise influences, so that the localization sharpness of the imaging methods is significantly improved, as is shown in FIG. 2d). The lateral cross-section, shown by a solid line in FIG. 2d), through the abdominal cavity reproduces the initially produced CT section. By taking into account the movement profile of the patient during the exposure time of the PET in the execution of an embodiment method according to the present invention, PET signal 24 can be precisely localized in the CT section. By back-calculating the movement patterns of the patient, which can be acquired on the basis of the patient's surface contour scanned using a LIDAR sensor, a significantly higher resolution is achieved in the localization of carcinoma 24.

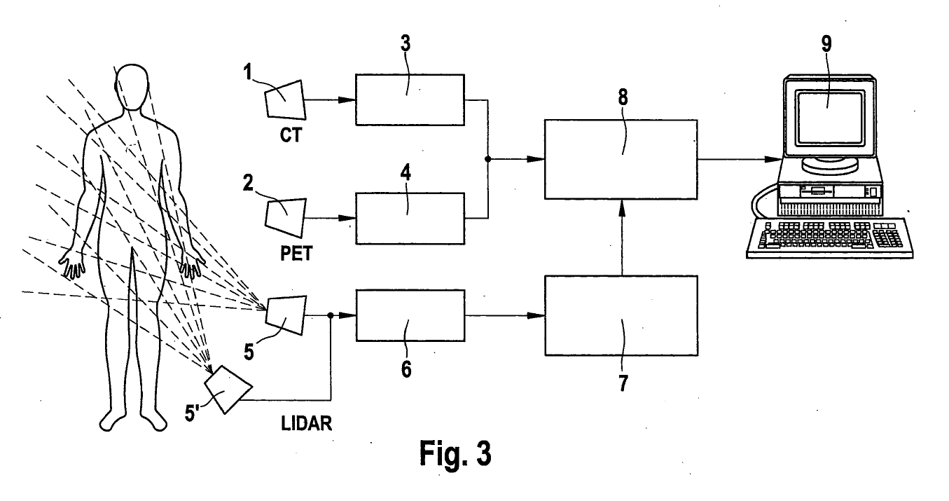

In example embodiments of the present invention, a further improvement in the scanning of the three-dimensional surface contour of a patient is enabled by the use of a plurality of LIDAR sensors. FIG. 3 illustrates a system of this sort that corresponds essentially to the system shown in FIG. 1.

Corresponding components have therefore been provided with the same reference characters. Differing from FIG. 1, LIDAR scanner 5 has two sensors 5, 5′, representing a system having a plurality of sensors. This specific embodiment permits shorter cycle times of the LIDAR sensor system, and more sensitively scanned surface contours, enabling a further improvement in the sensitivity of the method of the present invention and in the suppression of noise influences.

Example embodiment methods of the present invention illustrated in the Figures, or corresponding diagnostic device embodiments of the present invention, show a separate situation and signal preparation of individual sensor systems 1, 2, and 5. In embodiments, the various sensor systems may be combined with one another in a single device, and the process of the signal preparation and correlation of the various data may also be realized differently than is illustrated here.

What is claimed is:

1. A method for stabilizing imaging methods in medical diagnostics, comprising:
acquiring a three-dimensional surface contour of an object; and
correlating the three-dimensional surface contour of the object with at least one imaging method.

2. The method as recited in claim 1, wherein the three-dimensional surface contour is acquired multiple times during the execution of the at least one imaging method.

3. The method as recited in claim 2, wherein for the acquisition of the three-dimensional surface contour, laser beams are used.

4. The method as recited in claim 1, wherein the imaging methods are computer tomography, magnetic resonance tomography, and/or positron emission tomography.

5. The method as recited in claim 1, wherein the three-dimensional surface contour is used as a reference coordinate system for the at least one imaging method.

6. A medical diagnostic device having at least one imaging device, wherein the at least one imaging device is provided for producing a three-dimensional surface contour of a patient.

7. The diagnostic device as recited in claim 6, wherein the device for producing a three-dimensional surface is at least one laser scanner, in particular a LIDAR laser scanner.

8. The diagnostic device as recited in claim 6, wherein means are provided for correlating the three-dimensional surface contour with the imaging.

9. The diagnostic device as recited in claim 6, wherein the imaging device is at least one computer tomograph, at least one magnetic resonance tomograph, and/or at least one positron emission tomograph.

10. A use of a three-dimensional surface contour of a patient for stabilizing imaging methods in medical diagnostics.

11. The use as recited in claim 10, wherein in order to acquire the three-dimensional surface contour laser beams, at least one laser scanner is provided.

12. The use as recited in claim 10, wherein the imaging method is computer tomography, magnetic resonance tomography, and/or positron emission tomography, in particular CT/PET or MRT/PET.

13. A computer program that executes all the steps of a method as recited in claim 1 when run on a computing device.

14. A computer program product having program code that is stored on a machine-readable carrier for the execution of a method when the program is executed on a computer, the method being for stabilizing imaging methods in medical diagnostics, comprising acquiring a three-dimensional surface contour of a patient and correlating the three-dimensional surface contour with at least one imaging method.

15. The diagnostic device as recited in claim 6, wherein the imaging device is at least one CT/PET or at least one MRT/PET.

16. The method as recited in claim 2, wherein for the acquisition of the three-dimensional surface contour, laser beams in a LIDAR method are used.

17. The method as recited in claim 16, wherein the laser beams in a scanning LIDAR method are used.

18. The method as recited in claim 4, wherein the imaging methods are computer tomography and positron emission tomography, or magnetic resonance tomography and positron emission tomography.

19. The method as recited in claim 1, wherein the three-dimensional surface contour is used as a reference coordinate system for the imaging method, the reference coordinate system being used in a sectional plane correlation of CT and PET and/or of MRT and PET.

20. The use as recited in claim 10, wherein the imaging method is at least one of CT/PET and MRT/PET.
